(19) United States
(12) Patent Application Publication
(10) Pub. No.: US 2010/0246968 A1
(43) Pub. Date: Sep. 30, 2010

(54) IMAGE CAPTURING APPARATUS, IMAGE PROCESSING METHOD AND RECORDING MEDIUM

(75) Inventors: Hiroyuki HOSHINO, Tokyo (JP); Hiroshi Shimizu, Tokyo (JP); Jun Muraki, Tokyo (JP); Erina Ichikawa, Sagamihara-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Casio Computer Co., Ltd., Tokyo (JP)

(21) Appl. No.: 12/748,706

(22) Filed: Mar. 29, 2010

(30) Foreign Application Priority Data
Mar. 31, 2009 (JP) 2009-085970

(51) Int. Cl. G06K 9/46

(52) U.S. Cl. 382/190

(57) ABSTRACT

An image capturing apparatus 100 comprises an electronic image capture subunit 2, a determiner 8a, an image acquisition control unit 8b and a subject image extractor 8c. The determiner 8a sequentially determines whether a subject image is present in each of the images captured sequentially by the image capture subunit 2. The image acquisition control unit 8b acquires a subject-present background image and a subject-absent background image based on the result of the determination by the determiner 8a. The subject image extractor 8c extracts the subject image from the subject-background image based on difference information between each pair of corresponding pixels of the subject-background image and the background image each acquired by the image acquisition control unit 8b.

### CROSS-REFERENCE TO RELATED APPLICATION

This application is based on Japanese Patent Application No. 2009-085970 filed on Mar. 31, 2009 and including specification, claims, drawings and summary. The disclosure of the above Japanese patent applications is incorporated herein by reference in its entirety.

### BACKGROUND OF THE INVENTION

1. Field of the Invention

The present invention relates to image capturing apparatus, image processing methods and recording mediums.

2. Background Art

In the past, techniques are known for capturing a subject-present background image where a subject image is present in a background image and a subject-absent background where no subject image is present in the background image, for producing difference information from these images, and then for extracting the subject image only, as disclosed in JP 1998-21408. In order to extract the subject image only, this publication requires to capture these two images separately, and hence two shutter operations are required, which is troublesome.

### SUMMARY OF THE INVENTION

It is therefore an object of the present invention to provide an image capturing apparatus, image processing method and recording medium which is capable of extracting a subject image area easily in a single capturing operation.

In accordance with an aspect of the present invention, there is provided An image capturing apparatus comprising: an image capture unit; a determiner configured to determine whether a subject image is present in each of images captured sequentially by the image capture unit; an image acquirer configured to acquire a subject-present background image where a subject image is present in a background image and a subject-absent background image where no subject image is present in the background image, based on a result of the determination of the determiner; and a subject image extractor configured to extract the subject image from the subject-present background image based on difference information between each pair of corresponding pixels of the background image and the subject-present background image each acquired by the acquirer.

In accordance with another aspect of the present invention, there is provided an image processing method comprising: determining whether a subject image is present in each of images captured sequentially; acquiring a subject-present background image where a subject image is present in a background image and a subject-absent background image where no subject image is present in the background image, based on a result of the determination; and extracting the subject image from the subject-present background image based on difference information between each pair of corresponding pixels of the acquired background image and subject-present background image.

In accordance with still another aspect of the present invention, there is provided a software program product embodied in a computer readable medium for performing the method of an image processing.

### BRIEF DESCRIPTION OF THE DRAWINGS

The accompanying drawings, which are incorporated in and constitute a part of the specification, illustrate presently preferred embodiments of the present invention and, together with the general description given above and the detailed description of the preferred embodiments given below, serve to explain the principles of the present invention.

FIG. 1 is a schematic block diagram of an image capturing apparatus of an embodiment 1 according to the present invention.

FIG. 2 is a flowchart indicative of one example of a subject image cutout process according to the image capturing apparatus of FIG. 1.

FIG. 3 is a flowchart continued to that of FIG. 2.

FIGS. 4A and 4B schematically illustrate one example of images involved in the subject image cutout process of FIG. 2.

FIG. 5 schematically illustrates another example of the images involved in the subject image cutout process of FIG. 2.

FIG. 6 schematically illustrates one example of a subject image cutout process according to a modification of the image capturing apparatus.

FIGS. 7A-7C schematically illustrate another example of images involved in the subject image cutout process to be performed by the modification.

FIG. 8 is a schematic block diagram of an image capturing apparatus according to an embodiment 2.

FIG. 9 is a flowchart indicative of one example of a subject image cutout process according to the image capturing apparatus of FIG. 8.

FIGS. 10A and 10B schematically illustrate one example of images involved in the subject image cutout process of FIG. 8.

### DETAILED DESCRIPTION OF THE INVENTION

### Embodiment 1

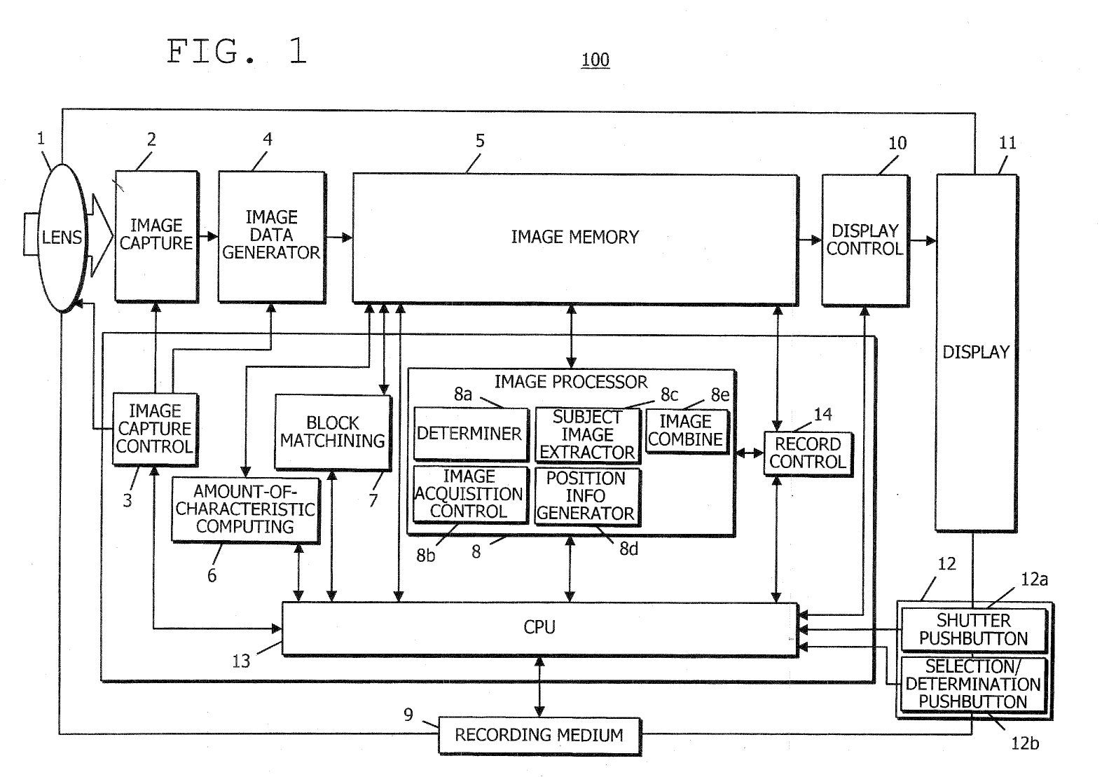

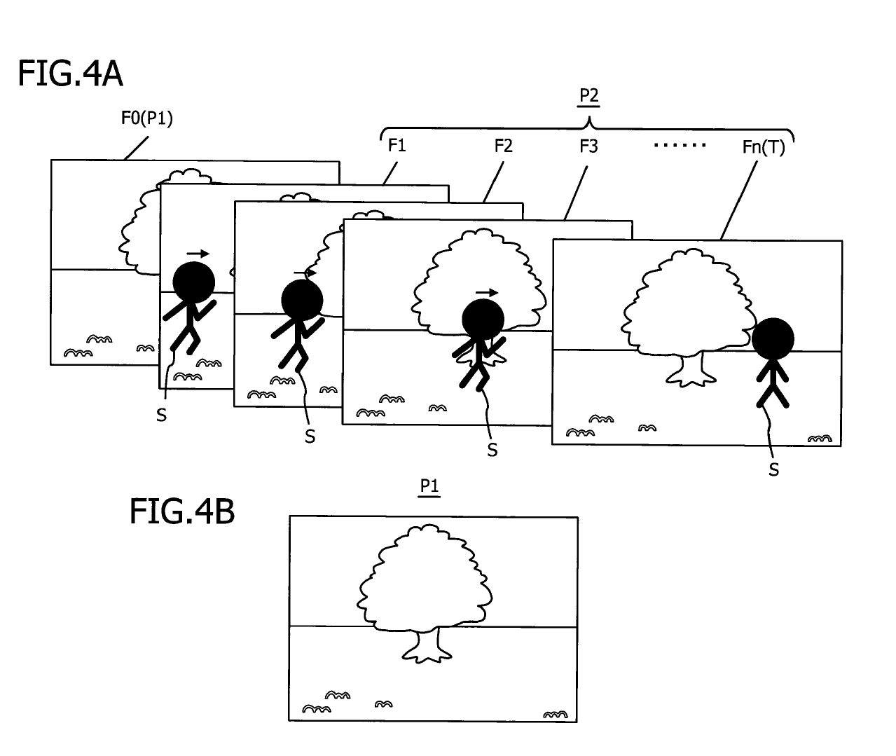

Referring to FIG. 1, an image capturing apparatus 100 according to the embodiment 1 of the present invention will be described. In FIG. 1, based on a plurality of image frames f0-fn (see FIG. 4A) captured by an electronic image capture subunit 2, the image capturing apparatus 100 determines whether a subject image S is present in a background image. Then, the image capturing apparatus 100 acquires a background image P1 (see FIG. 4B) and a series of subject-background images P2 where a subject image is present in a background image for extraction of a subject image (see FIG. 4A) based on a result of the determination. Then, the image capturing apparatus 100 extracts a subject image from each of the series of subject-background images P2 based on difference information between each pair of corresponding pixels of the background image P1 and that subject-background image P2.

As shown in FIG. 1, the image capturing apparatus 100 comprises a lens unit 1, an electronic image capture subunit 2, an image capture control unit 3, an image data generator 4, an image memory 5, an amount-of-characteristic computing unit 6, a block matching unit 7, an image processor 8, a recording medium 9, a display control unit 10, a display 11, an operator input unit 12, a CPU 13 and a record control unit 14. The image capture control unit 3, amount-of-characteristic computing unit 6, block matching unit 7, image processor 8, and CPU 13 are designed, for example, as a custom LSI in the apparatus.

The lens unit 1 composes a plurality of lenses including a zoom and a focus lens. The lens unit 1 may include a zoom driver (not shown) which moves the zoom lens along an optical axis thereof when a subject image is captured, and a focusing driver (not shown) which moves the focus lens along the optical axis.

The electronic image capture subunit 2 comprises an image sensor such as a CCD (Charge Coupled Device) or a CMOS (Complementary Metal-Oxide Semiconductor) sensor which functions to convert an optical image which has passed through the respective lenses of the lens unit 1 to a 2-dimensional image signal.

The image capture control subunit 2 comprises a timing generator and a driver (none of which are shown) to cause the electronic image capture subunit 2 to scan and periodically convert an optical image to a 2-dimensional image signal, reads image frames on a one-by-one basis from an imaging area of the electronic image capture subunit 2 and then outputs them sequentially to the image data generator 4.

The image capture control unit 3 adjusts image capturing conditions such as AF (Auto Focusing), AE (Auto Exposing) and AWB (Auto White Balancing).

The lens unit 1, the electronic image capture subunit 2 and the image capture control unit 3 cooperate to capture the background image P1 and the series of subject-background images P2 for extracting subject images concerned.

The image data generator 4 appropriately adjusts the gain of each of R, G and B color components of an analog signal representing each of image frames transferred from the electronic image capture subunit 2. Then, the image data generator 4 samples and holds a resulting analog signal in a sample and hold circuit (not shown) thereof and then converts a second resulting signal to digital data in an A/D converter (not shown) thereof.

Then, the image data generator 4 performs, on the digital data, a color processing process including a pixel interpolating process and a γ-correcting process in a color processing circuit (not shown) thereof.

Then, the image data generator 4 generates a digital luminance signal Y and color difference signals Cb, Cr (YUV data). The luminance signal Y and color difference signals Cb, Cr outputted from the color processing circuit are DMA transferred via a DMA controller (not shown) to the image memory 5 which is used as a buffer memory.

The image memory 5 comprises, for example, a DRAM which temporarily stores data processed and to be processed by each of the amount-of-characteristic computing unit 6, block matching unit 7, image processor 8 and CPU 13. The image memory 5 also comprises a ring buffer capable of cyclically storing up to 20 image frames produced by the image data generator 4.

The amount-of-characteristic computing unit 6 performs a characteristic extracting process which includes extracting characteristic points from the background image P1 based on this image only. More specifically, the amount-of-characteristic computing unit 6 selects a predetermined number of or more block areas of high characteristics (or characteristic points) based, for example, on YUV data of the background image P1 and then extracts the contents of the block areas as a template (for example, of a square of 16×16 pixels). The characteristic extracting process includes selecting block areas of high characteristics convenient to track from among many candidate blocks.

The block matching unit 7 performs a block matching process for causing the background image P1 and each of the series of subject-background images P2 to coordinate with each other when a cutout subject image concerned is produced. More specifically, the block matching unit 7 searches for areas or locations in each of the series of subject-background images P2 where the pixel values of that subject-background image P2 optimally match the pixel values of the template.

Then, the block matching unit 7 computes a degree of dissimilarity between each pair of corresponding pixel values of the template and each of the series of subject-background images P2 in a respective one of the locations or areas. Then, the block matching unit 7 computes, for each location or area, an evaluation value involving all those degrees of dissimilarity (for example, represented by Sum of Squared Differences (SSD) or Sum of Absolute Differences (SAD)), and also computes, as a motion vector for the template, an optimal correcting value between the background image P1 and each of the series of subject-background images P2 based on the smallest one of the evaluated values.

The image processor 8 comprises a determiner 8a which determines whether a subject image S is present in the background image, based on the plurality of image frames stored cyclically in the image memory 5. More specifically, the determiner 8a detects a dynamic body image including a difference between the background image and each of the image frames stored cyclically in the image memory 5 based on these image frames, using a predetermined dynamic body image analyzing technique. When no dynamic body is detected in the image frame, the determiner 8a determines that there is no subject image S in the background image.

When determining that a subject image is present in the background image in one of the image frames F1-Fn and then that no subject image is present in the background image in a next one of the image frames F1-Fn, CPU 13 determines that the status of the image frames has changed from a state where a subject image is present in the background image to a state where no subject image is present in the background image, and vice versa.

The image processor 8 comprises an image acquisition control unit 8b which acquires the background image P1 and each of a series of subject-background images P2, for extracting a subject image concerned, from the image frames stored in the image memory 5, based on a result of the determination of the determiner 8a.

More specifically, when the determiner 8a determines that the status of the image frames has changed from the state in which no subject image S is present in the background image to the state in which a subject image S is present, the image acquisition control unit 8b starts to acquire the image frames including the series of subject-background images P2 captured by the image capture subunit 2 and stored in the image memory 5 after the status of the image frames has changed.

Then, the image acquisition control unit 8b terminates the acquisition of the image frames at a timing point determined by a memory capacity or a specified acquisition period of time. That is, after the determiner 8a determines that the status of the image frames has changed from the state where no subject image is present in the background image to the state where a subject image S is present, the image acquisition control unit 8b acquires a plurality of image frames including the series of subject-background images P2 for a predetermined period of time.

When the determiner 8a determines that the status of the image frames has changed from the state where no subject image is present in the background image to the state where a subject image S is present, the image acquisition control unit 8b acquires any one of the image frames produced by the image data generator 4 and stored in the image memory 5 before the determination was made; for example, an image frame produced immediately before the determination was made as a background image P1 where no subject image is present.

The image processing subunit 8 comprises a subject image extractor 8c which extracts a subject image S from each of the series of subject-background images P2 acquired by the image acquisition control unit 8b. More specifically, the subject image extractor 8c extracts a subject image S from each of the series of subject-background images P2 based on difference information between each pair of corresponding pixels between the background image P1 and that subject-background image P2 acquired by the image acquisition control unit 8b.

The image processor 8 also comprises a position information generator 8d which specifies the position of a subject image S extracted from each of the series of subject-background images P2 and generates information on the position of the subject image in that subject-background image P2 (for example, alpha map). In the alpha map, each of the pixels of each of the series of subject-background images P2 has an alpha value (0≦+≦1) indicative of a weight with which the subject image is alpha blended with a predetermined background.

More specifically, the position information generator 8d produces alpha values by causing a binarized dissimilarity degree map where a largest one and others of the areas are expressed by 1 and 0, respectively, to pass through a low pass filter, thereby producing intermediate values as an alpha value in the boundary. In this case, the subject area has an alpha value of 1, and a transmittance of the subject-background images P2 to a predetermined background is 0%. The background of the subject image S has an alpha value of 0. The transmittance of the subject-background image P2 is 100%. Since the boundary area has an alpha value where 0≦α≦1, each of the series of subject-background images P2 blends with the background image P1.

The image processor 8 comprises an image combine unit 8e which combines the subject image S and a predetermined monochromatic image to generate image data of a combined image such that pixels of the subject-background image P2 with an alpha value of 1 are displayed to the predetermined monochromatic image and pixels of the subject-background image P2 with an alpha value of 0 are not displayed.

More specifically, the image combine unit 8e creates a subject area-free monochromatic image by cutting out the subject area from the monochromatic image, using a 1's complement, or (1−α), in the alpha map, and then combines the subject area-free monochromatic image and a subject image S cutout from each of the series of subject-background images P2, using the alpha map, thereby producing a cutout subject image.

The record control unit 14 records, as a still image T, a last acquired one fn of the plurality of image frames F1-Fn including the series of subject-background images P2 acquired by the image acquisition control unit 8b.

The recording medium 9 comprises, for example, a non-volatile (or flash) memory, which stores the image data of the cutout subject image encoded by a JPEG compressor (not shown) of the image processor 8. The recording medium 9 records each of the image frames produced by the cooperation of the lens unit 1, image capture subunit 2 and image capture control unit 3 as moving image data of the cutout subject image encoded in a predetermined compression type, for example in an motion-JPEG form, by an encoder (not shown) of the image processor 8.

The motion image data of the cutout subject image is stored as a file on the recording medium 9 in such a manner that the image frames of the cutout subject image correspond to the respective alpha maps produced by the position information generator 8d.

The display control unit 10 reads image data for display stored temporarily in the image memory 5 and displays it on the display 11. The display control unit 10 comprises a VRAM, a VRAM controller, and a digital video encoder (none of which are shown). The video encoder periodically reads a luminance signal Y and color difference signals Cb, Cr, which are read from the image memory 5 and stored in the VRAM under control of CPU 13, from the VRAM via the VRAM controller. Then, the display control unit 10 generates a video signal based on these data and then displays the video signal on the display 11.

The display 11 comprises, for example, a liquid crystal display which displays a captured image based on a video signal from the display control unit 10. More specifically, in the image capturing mode, the display 11 displays live view images based on respective image frames of the subject captured by the cooperation of the lens unit 1, the electronic image capturer subunit 2 and the image capture control unit 3, and also displays actually captured images on the display 11.

The operator input unit 12 is used to operate the image capturing apparatus 100. More specifically, the operator input unit 12 comprises a shutter pushbutton 12a to give a command to capture a subject image, a selection/determination pushbutton 12b which selects and gives a command to select one of a plurality of image capturing modes or functions, and a zoom pushbutton (not shown) which gives a command to adjust a quantity of zooming. The operator input unit 12 provides an operation command signal to CPU 13 in accordance with operation of a respective one of these pushbuttons.

CPU 13 controls associated elements of the image capturing apparatus 100, more specifically, in accordance with corresponding processing programs (not shown) stored in the image capturing apparatus 100.

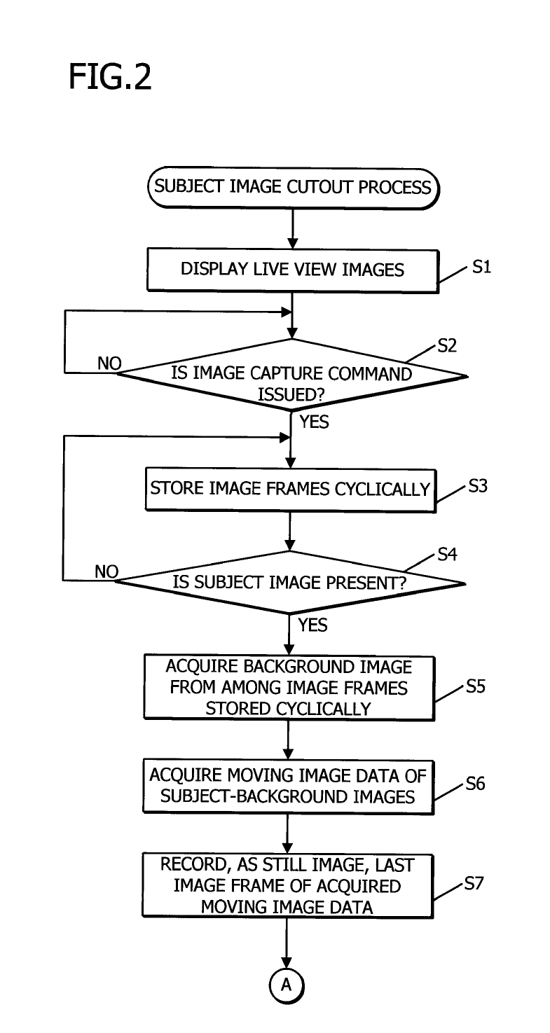

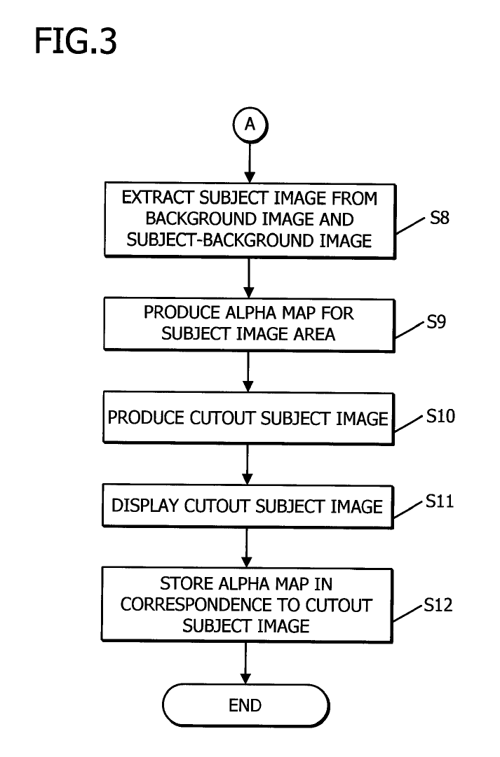

Referring to a flowchart of FIGS. 2 and 3, a subject image cutout process which is performed by the image capturing apparatus 100 will be described. This process is performed when a subject image cutout mode is selected from among the plurality of image capturing modes displayed on a menu picture, by the operation of the pushbutton 12b of the operator input unit 12. The image capturing process in the subject image cutout mode is performed by the image capturing apparatus 100 set at a fixed position, for example, on a tripod, desk or shelf.

As shown in FIG. 2, first, CPU 13 causes the display control unit 10 to display live view images on the display 11 based on respective image frames of the subject captured by the cooperation of the lens unit 1, the image capture subunit 2 and the image capture control unit 3. CPU 13 also causes the display control unit 10 to display, on the display 11, a message to request to capture images for extraction of the subject image so as to be superimposed on each of the live view images (step S1).

Then, CPU 13 causes the image capture control unit 3 to adjust a focused position of the focus lens and then determines whether the shutter pushbutton 12a is operated (step S2).

If it does (step S2, YES), CPU 13 causes the image capture subunit 2 to sequentially capture optical images formed as image frames by the lens unit 1. Then, CPU 13 sequentially stores the image frames, produced in this image capturing operation, in a ring buffer of the image memory 5. After the storage capacity is full, CPU 13 sequentially overwrites an oldest image frame data with a newest one, thereby cyclically storing a plurality of image frames for a predetermined period of time (step S3).

When determining that no shutter pushbutton 12a is operated (step S2, NO), CPU 13 iterates the determining step S2 until determining that the shutter pushbutton 12a has been operated.

When starting to cyclically store the plurality of image frames in the image memory 5, CPU 13 causes a determiner 8a to determine whether a subject image S is present in the background image in each of the plurality of image frames (step S4). More specifically, CPU 13 causes the determiner 8a to detect a dynamic body image based on the background image and each of the sequentially captured image frames, using a well-known dynamic body image analyzing technique.

If no dynamic body image is detected, CPU 13 determines that no subject image S is present in the background image. If the dynamic body image is detected, the determiner 8a determines that a subject image S is present in the background image. That is, when determining that a subject image is present in the background image in one of the image frames and then that no subject image is present in the background image in a next one of the image frames, CPU 13 determines that the status of the image frames has changed from a state where a subject image is present in the background image to a state where no subject image is present in the background image, and vice versa.

When the determiner 8a still determines that the status of the image frames has not changed from the state where no subject image S is present in the background image to the state where the subject image S image is present (step S4, NO), CPU 13 returns its processing to step S3 to store the plurality of image frames cyclically (step S3).

When the determiner 8a detects the subject image S in the background image and determines that the status of the image frames has changed from the state where no subject image S is present in the background image to the state where the subject image S is present (step S4, YES), CPU 13 causes the image acquisition control unit 8b to acquire, as a background image P1, a subject-absent image frame f0 (FIG. 4A) stored in the image memory 5 immediately before the determination in step S4 (step S5).

After the determination, CPU 13 causes the electronic image capture subunit 2 to capture a plurality of image frames F1-Fn in each of which the subject image S is present, for a predetermined period of time, and then causes the image acquisition control unit 8b to acquire moving image data of the image frames F1-Fn including the series of subject-background images P2 (step S6, FIG. 4A). Then, CPU 13 causes the record control unit 14 to record, as a still image T, a last captured image frame fn of the moving image data involving the series of subject-background images P2 acquired in step S6 in the predetermined area of the recording medium 9 (step S7, FIG. 4A).

Then, as shown in FIG. 3, CPU 13 causes the subject image area extractor 8c to extract the subject image from the background image P1 acquired in step S5 and each of the series of subject-background images P2 acquired in step S6 (step S8). More specifically, CPU 13 controls the subject image area extractor 8c to cause the YUV data of the respective image frames F1-Fn including the series of subject-background images P2 acquired in step S6 and the YUV data of the background image P1 acquired in step S5 to pass through low pass filters to eliminate high frequency components of the respective YUV data.

Then, CPU 13 causes the subject image area extractor 8c to compute a degree of dissimilarity between each pair of corresponding pixels in the background image P1 which is filtered and a respective one of the filtered frame images F1-Fn, thereby producing a dissimilarity degree map. Then, CPU 13 causes the subject image area extractor 8c to binarize the map with a predetermined threshold, and then performs a shrinking process to eliminate, from the dissimilarity degree map, areas where dissimilarity has occurred due to fine noise and/or blurs.

Then, the subject image area extractor 8c performs a labeling process on the map, thereby specifying a pattern of a maximum area as the subject image in the labeled map, and then performs an expanding process to correct possible shrinks which have occurred to the subject image area.

Then, CPU 13 causes the position information generator 8d to produce an alpha map indicative of the position of a subject image in each of the image frames F1-Fn from which the subject image is extracted (step S9).

Then, CPU 13 causes the image combine unit 8e to generate motion image data of a cutout subject image obtained by combining a predetermined monochromatic image and a subject image S in each of the image frames F1-Fn (step S10).

More specifically, CPU 13 causes the image combine unit 8e to read a subject image S and alpha map for each of the image frames F1-Fn and the monochromatic image from the recording medium 9 and loads these data on the image memory 5. Then, CPU 13 prevent the image combine unit 8e from displaying pixels of the subject image with an alpha (α) value of 0 for each image frame F1-Fn to the predetermined monochromatic pixel. Then, CPU 13 causes the image combine unit 8e to blend pixels of the subject image with an alpha value greater than 0 and smaller than 1 with the predetermined monochromatic pixel. Then, CPU 13 causes the image combine unit 8e to display pixels of the subject image with an alpha value of 1 to the predetermined monochromatic pixel.

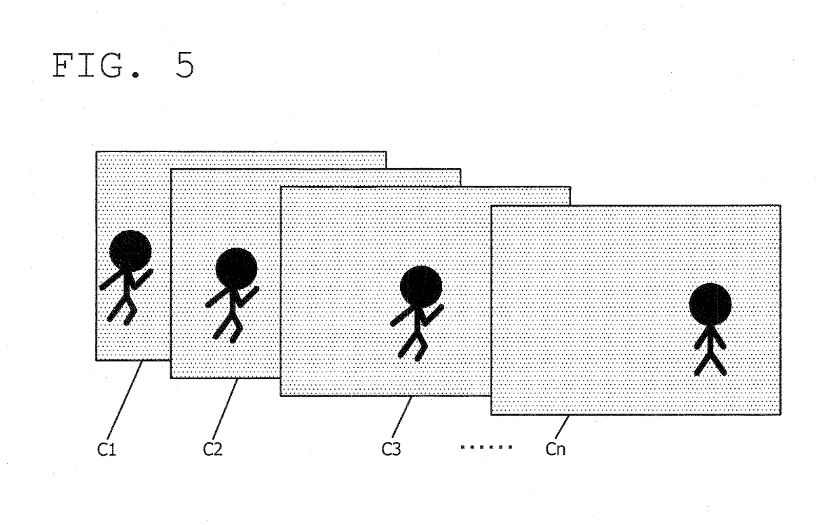

Then, based on the image data of the image frames C1-Cn (see FIG. 5) of the cutout subject image produced by the image combine unit 8e, CPU 13 causes the display control unit 10 to reproduce and display image frames, each indicative of a cutout subject image which includes a superimposed subject image and monochromatic image, on the display 11 at a predetermined frame rate, thereby reproducing a motion image of the cutout subject images (step S11).

Then, CPU 13 stores, in a predetermined area of the recording medium 9, a file of motion image data of the cutout subject image where image data of the image frames C1-Cn of the cutout subject image correspond to the alpha maps produced by the position information generator 8d (step S12). Then, the subject image cutout process terminates.

As described above, according to the image capturing apparatus 100 of this embodiment, the determiner 8a determines whether a subject image S is present in the background image in each of the plurality of image frames including the series of subject-background images P2 captured by the image capture subunit 2. If it does, the image acquisition control unit 8b acquires the background image P1 and the series of subject-background images P2 for extracting subject images concerned from the image memory 5.

More specifically, based on the plurality of image frames sequentially captured by the electronic image capture subunit 2, the determiner 8a determines whether the status of the image frames has changed from the state in which no subject image is present in the background to the state where the subject image S is present. If it does, the image acquisition control unit 8b acquires one of background images P1, where no subject image S is present in the background, captured by the electronic image capture subunit 2 before the determination, and after the determination, the image acquisition control unit 8b acquires the series of subject-background images P2 each composed of a respective one of the plurality of image frames F1-Fn captured by the image capture subunit 2.

Thus, when acquiring the background image P1 and the series of subject-background images P2 for extracting subject images concerned, the user need not perform two image capturing operations including capturing the background image P1 and the series of subject-background images P2 separately. That is, only by operating the shutter pushbutton once, the user can easily acquire the background image P1 and the series of subject-background images P2 and can hence extract the subject image area using these images.

Among the image frames F1-Fn including the series of subject-background images P2 acquired by the record control unit 14, the last image frame fn is recorded as a still image T on the recording medium 9. Thus, only by operating the shutter pushbutton 12a once, the extracted subject-only images C1-Cn are easily produced as well as a still image T is produced from the background image P1 and each of the series of subject-background images P2.

In the embodiment 1, a self-timer mode in which a still image is captured, using a self-timer, may be set such that a usual still image in which a subject image is present in the background image may be captured and recorded after images for extraction of the subject image in the subject cutout process are acquired.

<Modification>

A modification of the image capturing apparatus of the embodiment 1 will be described. The modification has substantially the same structure as the embodiment 1 and main structural parts of the modification different from the embodiment 1 will be described.

In the modification, when the shutter pushbutton 12a is operated in a self-timer mode at the operation input unit 12, a command to cause the lens unit 1, the image capture subunit 2 and the capture control unit 3 to cooperate to capture an image of a subject is automatically output to CPU 13 when a predetermined set time has elapsed. In response to this signal, CPU 13 outputs a signal to the image capture control unit 3 to cause the image capture subunit 2 to capture the image.

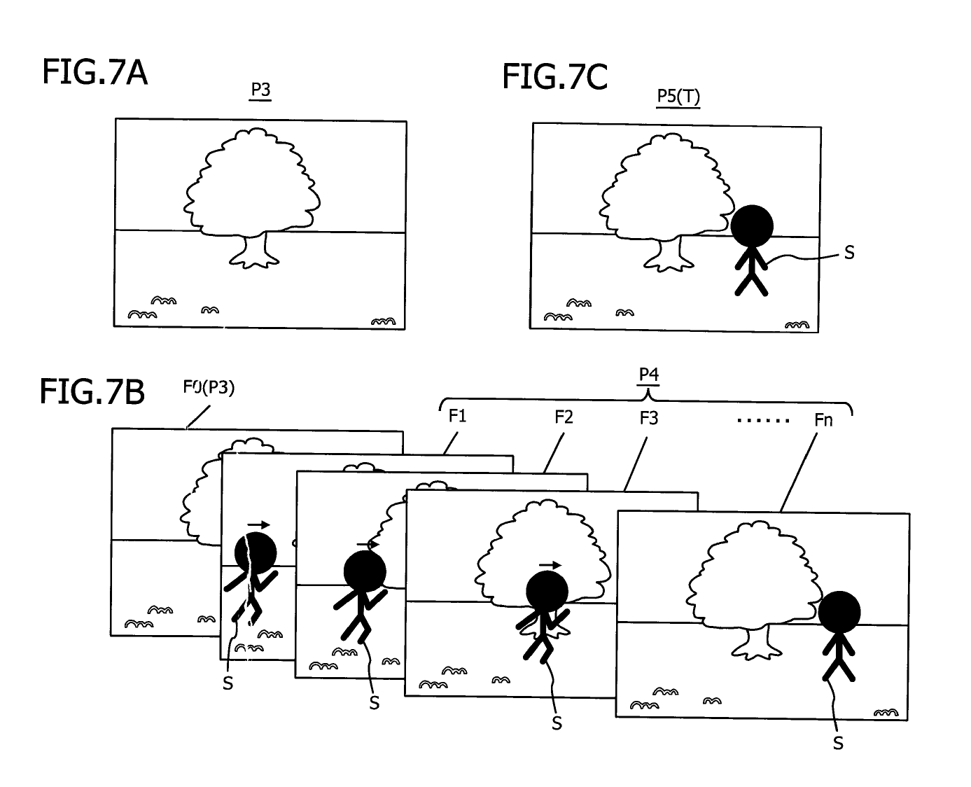

Receiving the image capture command from the shutter pushbutton 12a, CPU 13 causes the lens unit 1, the image capture subunit 2 and the image capture control unit 3 to cooperate to capture a background image P3 where no subject image S is present in the background image (see FIG. 7A). When the determiner 8a determines that the status of the image frames has changed from the state where no subject image is present in the background image to the state where a subject image S is present, CPU 13 causes the lens unit 1, the image capture subunit 2 and the image capture control unit 3 to cooperate to capture image frames F1-Fn (see FIG. 7B) of a series of subject-background images P4.

When the determiner 8a determines that the status of the image frames has changed from the state where no subject image is present in the background image to the state where a subject image S is present, the image acquisition control unit 8b starts to acquire the image frames F1-Fn including the series of subject-background images P4 captured sequentially by the cooperation of the lens unit 1, image capture subunit 2 and the image capture control unit 3 and then terminates acquisition of the image frames F1-Fn when a predetermined time has elapsed since the operation of the shutter pushbutton 12a.

The record control unit 14 records, as a still images T (see FIG. 7C) in a predetermined area of the recording medium 9, a subject-background image P5 captured automatically by the image capture subunit 2 when a predetermined time has elapsed since the shutter pushbutton 12a has been operated.

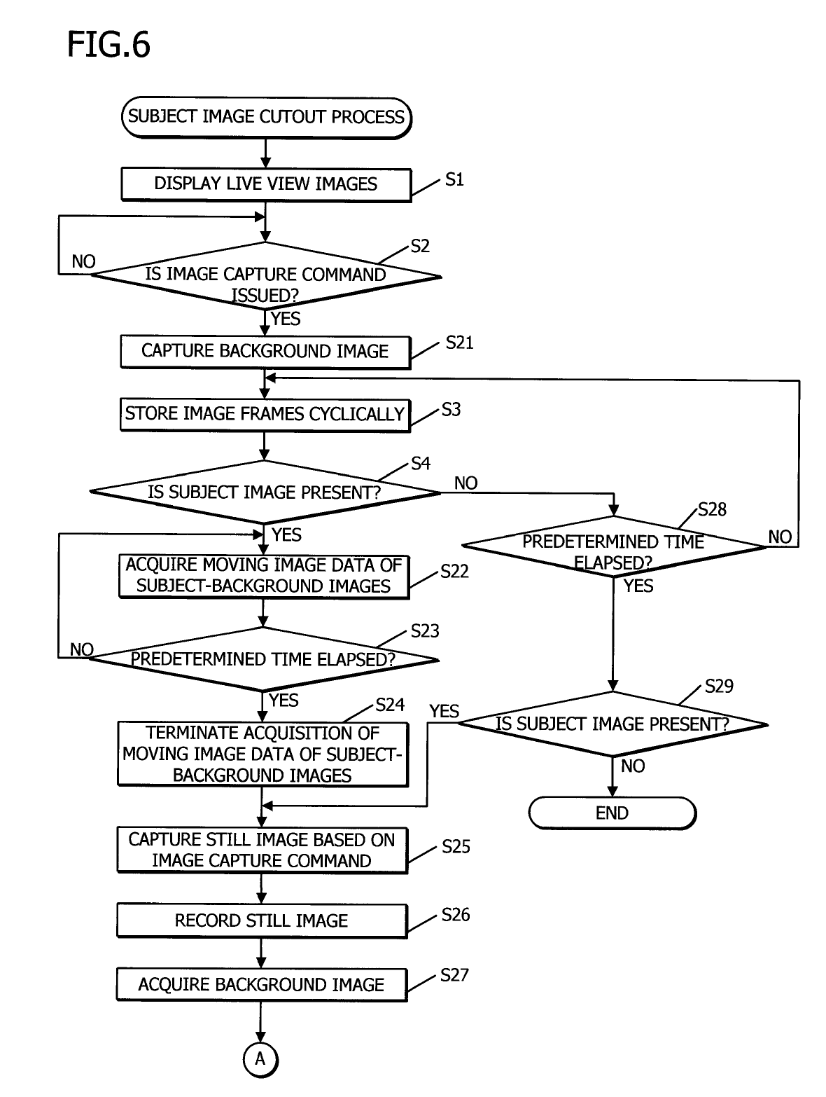

A subject image cutout process by the modification will be described with reference to FIG. 6. FIG. 6 is a flowchart of the subject image cutout process to be performed when a subject image cutout mode and the self-timer mode are selected from among the plurality of image capture modes displayed on the menu picture, based on the operation of the selection/determination button 12b.

As shown in FIG. 6, like the first embodiment 1, first, CPU 13 causes the display control unit 10 to display live view images and a message, which requests to capture a subject-image extraction image, on the display 11 such that the message is superimposed on the live view images (step S1).

Then, like the embodiment 1, CPU 13 determines whether the shutter pushbutton 12a has been operated (step S2). If it does, CPU 13 causes the lens unit 1, the image capture subunit 2 and the image capture control unit 3 to cooperate to capture a subject-absent background image P3 (see FIG. 7A) (step S21).

Then, like the embodiment 1, CPU 13 cyclically stores, in the image memory 5, a plurality of image frames captured by the image capture subunit 2 for a predetermined period of time (step S3). Then, like the embodiment 1, CPU 13 causes the determiner 8a to determine whether the status of the image frames has changed from the state in which no subject image is present in the background image to the state where the subject image is present (step S4).

If it does, CPU 13 causes the image acquisition control unit 8b to acquire the frame images F1-Fn including the series of subject-background images P4 captured by the image capture subunit 2 and stored in the image memory 5 (step S22, FIG. 7B).

Then, CPU 13 determines whether the predetermined time has elapsed since the start of the self-timer by the shutter pushbutton 12a, thereby determining termination of the self-timer (step S23).

If it does not, CPU 13 returns its processing to step S22 to acquire the image frames including the series of subject-background images P4. When determining that the predetermined time has elapsed (step S23, YES), CPU 13 causes the image acquisition control unit 8b to terminate acquisition of the image frames F1-Fn of the subject-background image (step S24).

In addition, at this time, CPU 13 causes the lens unit 1, the image capture subunit 2 and the image capture control unit 3 to cooperate to capture a still subject-background image P5 (see FIG. 7C) (step S25). Then, the record control unit 14 records the subject-background image P5 as a still image T in the predetermined area of the recording medium 9 (step S26).

Then, in step S21, CPU 13 causes the image acquisition control unit 8b to acquire the image data of the background image P3 captured by the image capture subunit 2 (step S27). Step 27 and subsequent steps (see FIG. 3) are similar to corresponding ones of the embodiment 1 and further description thereof will be omitted.

When the determiner 8a determines in step S4 that the status of the image frames has not changed from the state where no subject image is present in the background image to the state where the subject image is present (step S4, NO), CPU 13 determines whether the predetermined time has elapsed since the start of the self-timer by the shutter pushbutton 12a, thereby determining termination of the self-timer (step S28).

If it does not, CPU 13 returns its processing to step S3 to acquire the image frames including the series of subject-background images P4. When determining that the predetermined time has elapsed (step S28, YES), CPU 13 causes the determiner 8a to determine whether the status of the image frames has changed from the state in which no subject image is present in the background image to the state where the subject image is present (step S29).

If it does not, the subject image cutout process terminates. When the determiner 8a determines in step S29 that the status of the image frames has changed from the state where no subject image is present in the background image to the state where the subject image is present (step S29, YES), CPU 13 causes the lens unit 1, the image capture subunit 2 and the image capture control unit 3 to cooperate to capture a still subject-background image P5 (see FIG. 7C) (step S25).

As described above, according to the modification, the image capture subunit 2 captures the background image P3 in which no subject image is present in the background image when the shutter pushbutton 12a is operated in the self-timer mode. When the determiner 8a determines that the status of the image frames has changed from the state where no subject image is present in the background image to the state where the subject image S is present, the image acquisition control unit 8b starts to acquire image frames F1-Fn including the series of subject-background images P4 produced sequentially by the image capture subunit 2. When a predetermined time has elapsed since operation of the shutter pushbutton 12a, acquisition of the image frames F1-Fn including the series of subject-background images P4 is terminated.

Thus, only by operating the shutter pushbutton 12a once, the user can easily acquire the background image P3 and the series of subject-background images P4 for extracting subject images concerned without performing two operations including capturing these images P3 and P4 separately. Thus, the user can easily extract the subject image area, using these images P3 and P4.

When the shutter pushbutton 12a is operated, the user can acquire a desired background image P3 and hence appropriately extract the subject image area.

The image capture control unit 3 records, as a still image T on the recoding medium 9, a subject-background image P5 captured automatically by the image capture subunit 2 when a predetermined time has passed since the shutter pushbutton 12a is operated.

Thus, the user can understand when the subject-background image P5 is captured, and hence extract the subject image area as well as acquire a still image appropriately.

### Embodiment 2

The embodiment 2 will be described with reference to the drawings. The embodiment 2 is similar in structure to the embodiment 1 and parts of the embodiment 2 different from the embodiment 1 will be mainly described.

The image processing subunit 8 comprises a determiner 8a which determines whether a subject image S is present in the background image, based on the plurality of image frames stored cyclically in the image memory 5. More specifically, the determiner 8a detects a dynamic body image for each of the image frames captured sequentially by the image captured subunit 2 and stored in the image memory 5, using the predetermined dynamic body analyzing technique. When detecting the dynamic body image, the determiner 8a determines that a subject image S is present in the background image. When detecting no dynamic body image, the determiner 8a determines that no subject image is present in the background image.

Like this, the determiner 8a determines whether the status of the sequentially captured frame images has changed from the state where the subject image S is present in the background image to the state where no subject image is present. Thus, the determiner 8a determines whether a subject image S is present in the background, based on the image frames produced by the image data generator 4.

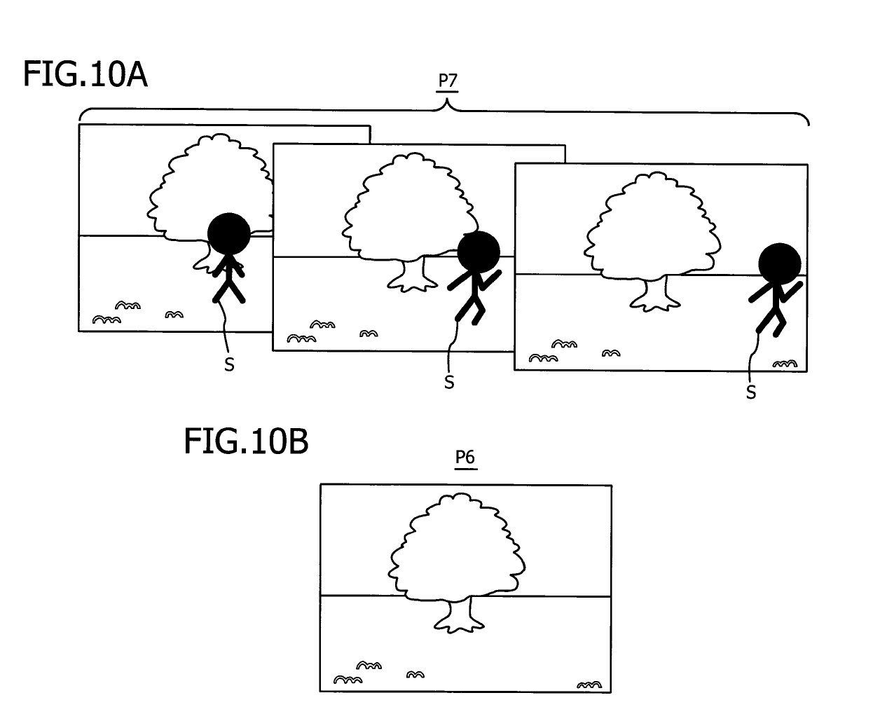

Like the embodiment 1, the image processor 8 comprises an image acquisition control unit 8b which, based on a result of the determination of the determiner 8a, acquires, from the image memory 5, a background image P6 (see FIG. 10B) and a series of subject-background images P7 (see FIG. 10A), captured by the electronic image capture subunit 2, for extracting subject images concerned.

More specifically, until the determiner 8a determines that the status of the image frames has changed from the state in which a subject image S is present in the background image to the state in which no subject image S is present, the image acquisition control unit 8b continues to acquire a series of subject-background images P7 captured by the image capture subunit 2, insofar as neither the memory capacity nor the acquisition time is limited.

When the determiner 8a determines that the status of the image frames has changed from the state where the subject image S is present in the background image to the state where no subject image is present, the image acquisition control unit 8b acquires a subject-free background image P6 captured by the image capture subunit 2 after the determination.

Thus, the image acquisition control unit 8b acquires, from the image memory 5, the background image P6 and the series of subject-background images P7 produced by the image data generator 4 for extracting subject images concerned, based on a result of the determination by the determiner 8a.

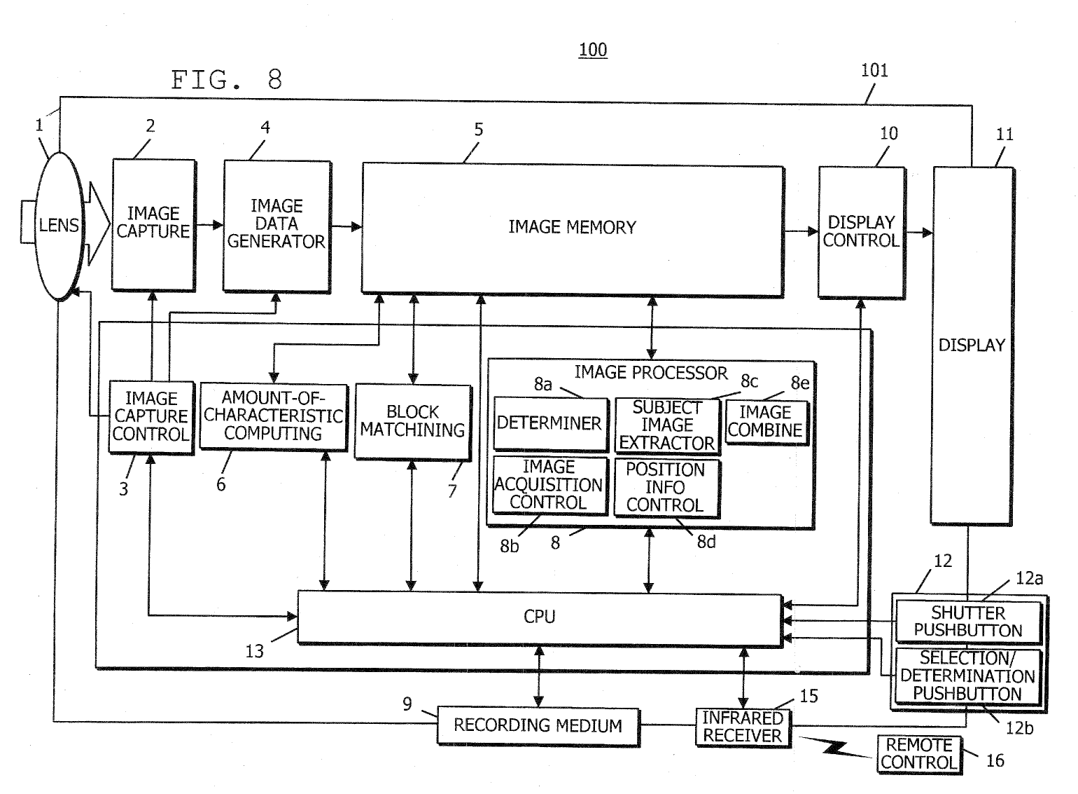

As shown in FIG. 8, the image capturing apparatus 100 also comprises an infrared receiver 15 in a body 101 thereof and a remote control 16 which sends a predetermined infrared operation signal to the infrared receiver 15 when operated remotely. The infrared receiver 15 in turn delivers a corresponding operation signal to CPU 13.

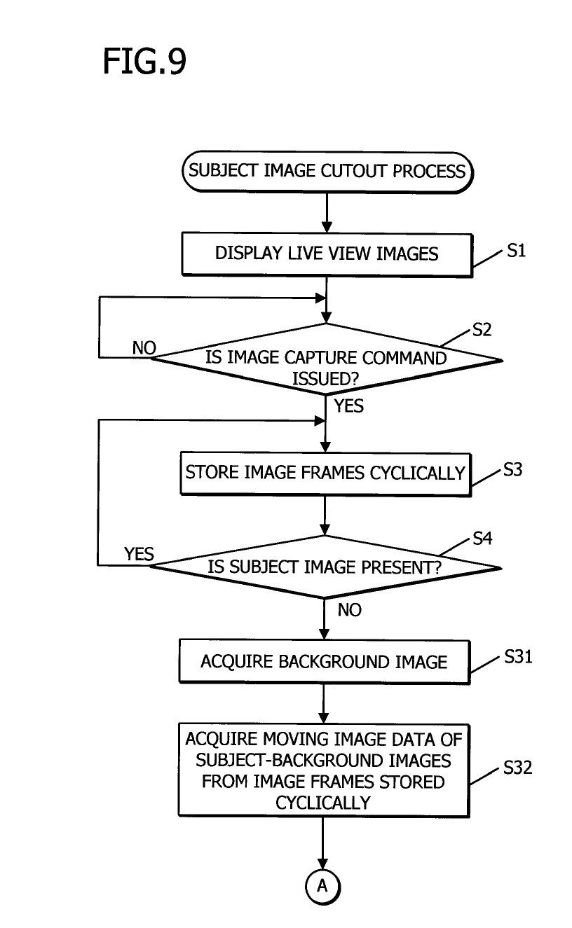

Referring to a flowchart of FIG. 9, a subject image cutout process by the image capturing apparatus 100 will be described. As shown in FIG. 9, like the embodiment 1, first, CPU 13 causes the display control unit 10 to display, on the display 11, live view images and a message to request to capture images for extracting a subject image concerned such that the message is superimposed on the respective live view images (step S1).

Then, CPU 13 causes the image capture control unit 3 to adjust a focused position of the focus lens and then determines whether the shutter pushbutton 12a has been operated by the remote control 16 (step S2).

If it does (step S2, YES), the image capture control unit 3 causes the image capture subunit 2 to immediately capture a series of optical frame images for extracting a subject image concerned, under predetermined image capturing conditions. Then, CPU 13 cyclically stores the image frames, produced in this image capturing operation, in the image memory 5 (step S3).

When determining that no shutter pushbutton 12a is operated remotely by the remote control 16 (step S2, NO), CPU 13 iterates the determining step S2 until determining that the shutter pushbutton 12a has been operated.

Then, CPU 13 causes the determiner 8a to determine whether a subject image S is present in the background image based on the plurality of image frames stored cyclically in the image memory 5 insofar as the determination is iterated in step S2 (step S4). More specifically, CPU 13 causes the determiner 8a to detect a moving body image for each of the plurality of image frames, using the predetermined moving body analyzing technique. If the moving body image is detected, CPU 13 determines that a subject image S is present in the background image. If no moving body image is detected, CPU 13 determines that no subject image is present. Using such method, CPU determines whether the status of the image frames has changed from the state in which the subject image S is present in the background image to the state where no subject image is present.

When the determiner 8a determines in step S4 that the status of the image frames has changed from the state in which the subject image S is present in the background image to the state where no subject image is present (step S4, NO), CPU 13 causes the image capture subunit 2 to capture a subject-free background image P6 after the determination and also causes the image acquisition control unit 8b to acquire a background image P6 (step S31).

Then, CPU 13 causes the image acquisition control unit 8b to acquire cyclically stored image frames F1-Fn including the series of subject-background images P7 captured by the electronic image capture subunit 2 and cyclically stored in the image memory 5 until CPU 13 determines that the status of the image frames has changed from the state where the subject image S is present in the background image to the state where no subject image is present (step S32).

When the determiner 8a does not determine in step S4 that the status of the image frames has changed from the state where the subject image S is present in the background image to the state where no subject is present, CPU 13 returns its processing to step S3 to store image frames cyclically (step S3). The processing in step S32 and subsequent steps (see FIG. 3) is similar to the processing in the corresponding ones of the embodiment 1 and further description thereof will be omitted.

As described above, according to the image capturing apparatus of the embodiment 2, the determiner 4a determines whether the subject image S is present in the background image, based on each of the image frames produced by the image data generator 4. If it does, the image acquisition control unit 8b acquires, from the image memory 5, the background image P6 and the series of subject-background images P7 produced by the image data generator 4 for extracting subject images concerned.

More specifically, the determiner 8a determines based on the image frames sequentially captured by the image capture subunit 2 whether the status of the image frames has changed from the state where a subject image S is present in the background image to the state where no subject image is present. If it does, the image acquisition control unit 8b acquires the subject-free background image P6 captured by the image capture subunit 2, and then at least one of the series of subject-background images P7 captured by the image capture subunit 2 until the determiner 8a determines that the status of the image frames has changed from the state where the subject image S is present in the background image to the state where no subject is present.

Thus, the user can easily acquire the background image P6 and the series of subject-background images P7 for extraction of the subject images concerned, only by giving an image capture command once without resorting to two separate operations to capture these images. Therefore, the user can easily extract the subject image, using these images. Since the series of subject-background images P7 where the apparatus is focused on the subject image S is captured earlier than the background image P6, the user can acquire the series of subject-background images P7, thereby enabling to extract the subject image area appropriately.

The present invention is not limited to the above embodiments. Various changes and modifications may be performed without departing from the spirit and scope of the present invention.

For example, in the above embodiments, the determiner 8a may use a face detecting technique when determining whether a subject image S is present in the background image. More specifically, the determiner 8a may determine that when detecting a man's face image from one of the image frames captured by the image capture subunit 2, the determiner 8a has determined that a man image as a moving body has been detected.

A well-known technique for authenticating a particular person's face may be used. More specifically, when detecting face data matching particular person's face data stored in a database from any one of the plurality of image frames captured by the image capture subunit 2, the determiner 8a may determine that the particular person image has been detected as a moving body image.

It is illustrated in the above embodiments and modification that the determiner 8a determines whether a subject image S is present in the background image, based on the image frames produced by the image data generator 4, and that the image acquisition control unit 8b acquires, from the image memory 5, the background image and the series of subject-background images produced by the image'data generator 4 for extracting the subject images concerned.

In contrast, the image capture control unit 3 may cause the image capture subunit 2 to capture the subject-background image or the background image based on a result of the determination by the determiner 8a. More specifically, the image capture control unit 3 may control the image capture subunit 2 so as to capture the subject-background image or the background image under its optimal image capturing conditions, apart from the image frames produced by the image data generator 4.

Alternatively, in the modification of the embodiment 1, the timing point when the self-timer starts is not limited to when the shutter pushbutton 12a is operated, but may be when the determiner 8a determines that the subject image S is present.

Although in the embodiments the determiner, the acquirer, and the subject image extractor are illustrated as implemented by the image processor 8 under control of CPU 13, the present invention is not limited to this particular case. The functions of these elements may be implemented in programs to be executed by CPU 13.

More particularly, a program memory (not shown) may prestore a program including a determination routine, an image acquisition control routine and a subject image extraction routine. The determination routine may cause CPU 13 to function as means for determining whether a subject image S is present in the background image based on the image frames produced by the image data generator 4.

The image acquisition control routine may cause CPU 13 to function as means for acquiring, from the image memory 5, the background image and the subject-background image captured by the image capture subunit 2 for extraction of the subject image, based on a result of the determination by the determination routine. The subject image extraction routine may cause CPU 13 to function as means for extracting the subject image S from the subject-background image based on difference information between each pair of corresponding pixels between the background image and the subject-background image acquired in the image acquisition control routine.

What is claimed is:

1. An image capturing apparatus comprising:
an image capture unit;
a determiner configured to determine whether a subject image is present in each of images captured sequentially by the image capture unit;
an image acquirer configured to acquire a subject-present background image where a subject image is present in a background image and a subject-absent background image where no subject image is present in the background image, based on a result of the determination of the determiner; and
a subject image extractor configured to extract the subject image from the subject-present background image based on difference information between each pair of corresponding pixels of the background image and the subject-present background image each acquired by the acquirer.

2. The image capturing apparatus of claim 1, wherein:
when results of determination by the determiner for two consecutive ones of the images captured sequentially by the image capture unit differ, the image acquirer acquires the subject-present background image and the subject-absent background image from one and the other, respectively, of the two consecutive images.

3. The image capturing apparatus of claim 2, wherein:
when the determiner determines that no subject image is present in each of two or more consecutive ones of the images captured sequentially by the image capture unit and then that a subject image is present in a next one of the sequentially captured images, the image acquirer acquires, as a subject-absent background image, at least one of the two or more consecutive ones of the sequentially captured images.

4. The image capturing apparatus of claim 2, wherein:
when the determiner determines that no subject image is present in one of the images captured sequentially by the image capture unit and then that a subject image is present in each of next consecutive ones of the images captured sequentially by the image capture unit, the image acquirer acquires, as a subject-present background image, at least one of the next consecutive ones of the sequentially captured images.

5. The image capturing apparatus of claim 4, wherein:
when the determiner determines that no subject image is present in one of the images captured sequentially by the image capture unit and then that a subject image is present in each of next consecutive ones of the images captured sequentially by the image capture unit, the image acquirer acquires, as a still image for preservation, a subject-present-background image captured by the image capture unit a predetermined period of time after the last-mentioned determination made by the determiner.

6. The image capturing apparatus of claim 2, wherein:
when the determiner determines that subject image is present in one of the images captured sequentially by the image capture unit and then that a subject image is absent in a next one of the images captured sequentially by the image capture unit, the image acquirer acquires, as a subject-absent background image, the next one of the sequentially captured image.

7. The image capturing apparatus of claim 2, wherein:
when the determiner determines that a subject image is present in one of the sequentially captured images and then that no subject image is present in a next one of the sequentially captured images, the image acquirer acquires, as a subject-background image, the one of the images captured sequentially by the image capture unit.

8. An image processing method comprising:
determining whether a subject image is present in each of images captured sequentially;
acquiring a subject-present background image where a subject image is present in a background image and a subject-absent background image where no subject image is present in the background image, based on a result of the determination; and
extracting the subject image from the subject-present background image based on difference information between each pair of corresponding pixels of the acquired background image and subject-present background image.

9. A software program product embodied in a computer readable medium for performing the method of claim 8.
